(19) United States
(12) Patent Application Publication
(10) Pub. No.: US 2008/0113660 A1
(43) Pub. Date: May 15, 2008

(54) Method of dialing phone number prediction

(75) Inventors: Jui-Hsiang Chiang, Taipei (TW); Sean Mosko, Taipei (TW)

Correspondence Address: BACON & THOMAS, PLLC, 625 SLATERS LANE, FOURTH FLOOR, ALEXANDRIA, VA, 22314, US

(73) Assignee: FIRST INTERNATIONAL COMPUTER, INC., Taipei (TW)

(21) Appl. No.: 11/599,331

(22) Filed: Nov. 15, 2006

(51) Int. Cl. H04M 3/42

(52) U.S. Cl. 455/418

(57) ABSTRACT

A method of dialing phone number prediction to facilitate a phone user to dial a phone number. When the user enters a few digits (not the whole phone numbers) and the screen of the telephone will show possible dialing targets for user to select. Therefore the user does not have to enter the complete phone numbers to make a call.

### BACKGROUND OF THE INVENTION

1. Field of the Invention

The present invention relates to a method of dialing a phone number, for example used in a cell phone.

2. Description of the Related Art

When dialing a phone number on a mobile device there are two classic methods. The first method is to enter a string of numbers, then pressing a dial key to connect the call. The second method is by manually locating a contact's phone number from the phonebook and selecting an entry to dial. These both have their problems. The first method requires the user to remember a sometimes very long string of numbers. And the second method is quite cumbersome requiring many consecutive key sequences to first find the contact and finally to place a call.

It is therefore desirable to provide a better dialing method to mitigate and/or obviate the aforementioned problems.

### SUMMARY OF THE INVENTION

An object of the present invention is to let the user to enter a few digits (not the whole phone numbers) and the screen of the telephone will show possible dialing targets for user to select.

To achieve the object, method of dialing phone number prediction to facilitate a phone user to dial a phone number, comprises the steps of:

Step A: receiving at least one input digit;

Step B: displaying at least said one input digit;

Step C: comparing at least said one input digit with a phonebook, wherein the phonebook comprises a plurality of phone owners, and each phone owner has at least said one built phone number;

Step D: finding any possible dialing target from the phone owners, wherein at least said one built phone number of possible dialing target matches at least said one input digit;

Step E: displaying at least one of the possible dialing targets, according to the embodiment, at least one possible dialing target is highlighted defined as a chosen target which can be selected by the phone user;

Step F: go to Step A, if the user will input another digit; or the user connects the chosen target by pressing the dialing button.

Other objects, advantages, and novel features of the invention will become more apparent from the following detailed description when taken in conjunction with the accompanying drawings.

### BRIEF DESCRIPTION OF THE DRAWINGS

FIG. 1 shows a front view and functional block drawings of a telephone according to the present invention.

FIG. 2 shows a phonebook stored in the telephone according to the present invention.

FIG. 3 shows a flow chart of the present invention according to the present invention.

FIG. 4˜9 shows a step by step screen images according to the present invention.

### ELEMENT DESCRIPTION

| | | | |
|---|---|---|---|
| telephone | 10 | processor | 11 |
| memory | 12 | screen | 13 |
| input device | 14 | dialing button | 14d |
| microphone | 15 | speaker | 16 |
| wireless communication module | 17 | phonebook | 20 |
| phone owner | 21 | built phone number | 22~24 |
| address | 25 | | |
| possible dialing targets | 30 | chosen target | 40 |
| target phone number | 50 | | |

### DETAILED DESCRIPTION OF THE PREFERRED EMBODIMENT

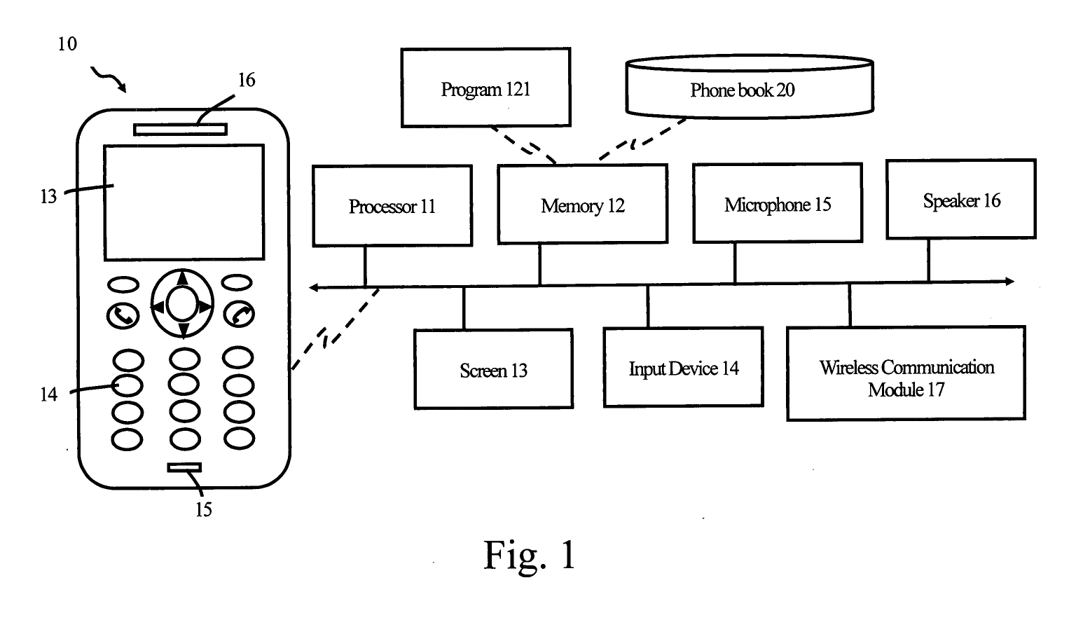

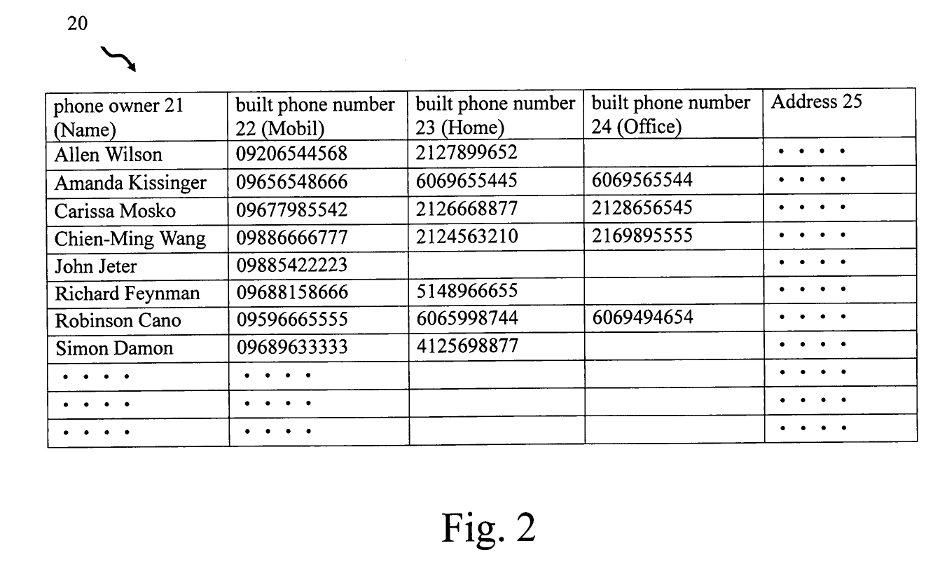

Please refer to FIG. 1. A telephone 10, such as a cell phone, comprises a processor 11, a memory 12, and a screen 13, an input device 14 (e.g. buttons, up or down keys), a microphone 15, a speaker 16, and a wireless communication module 17. The memory 12 (e.g. RAM, ROM, SDARM, Memory Disk) has a phonebook 20 and a software program 121 to be executed by the processor 11 to manage the operation or achieve certain functions. Because the mechanism and the circuit structure of the cell phone 10 is well known to those of reasonable skill in the art, the detailed description for doing so is omitted.

The phonebook 20 records several information, such as phone owner 21, built phone number 22˜24, and address 25.

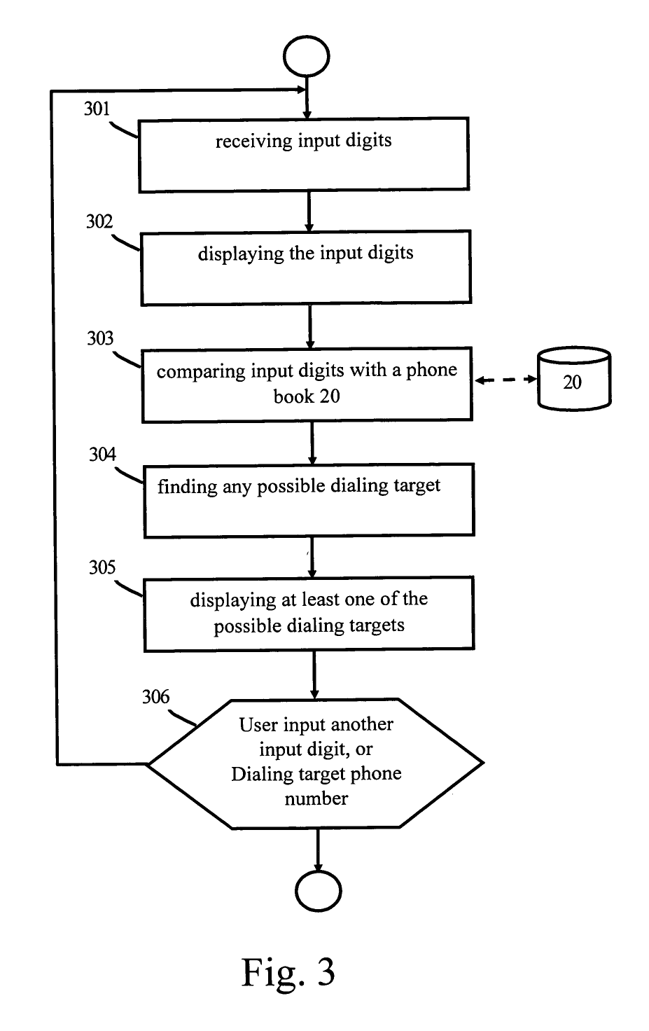

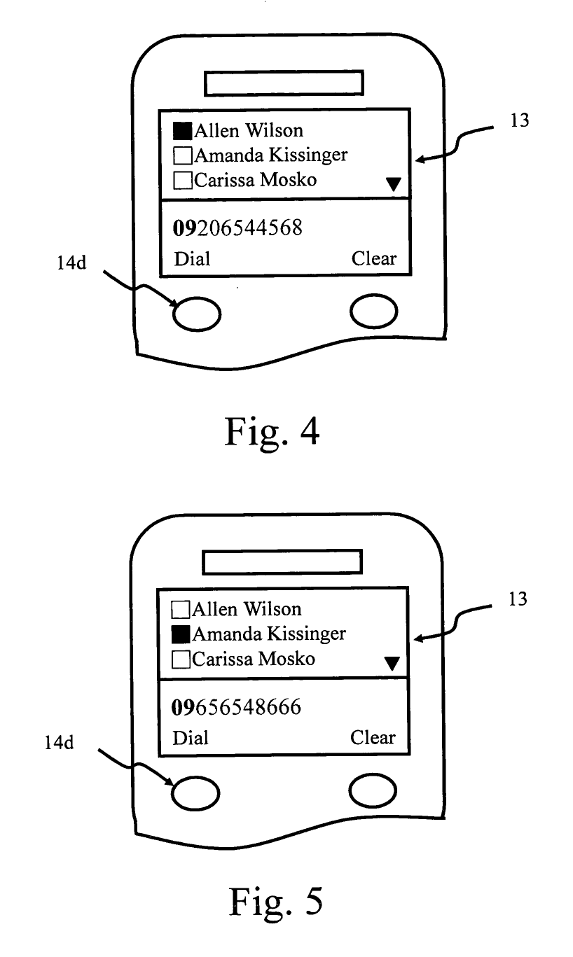

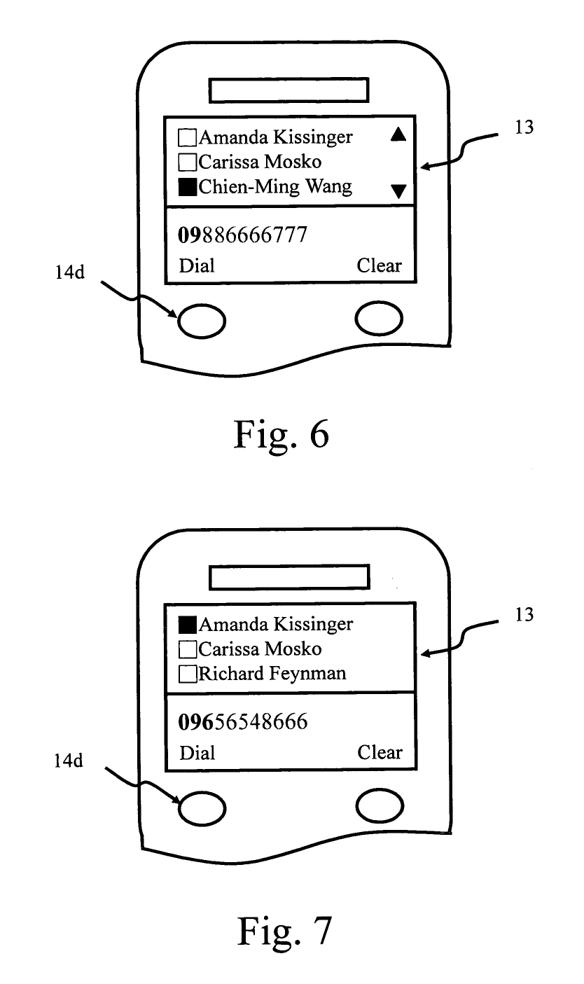

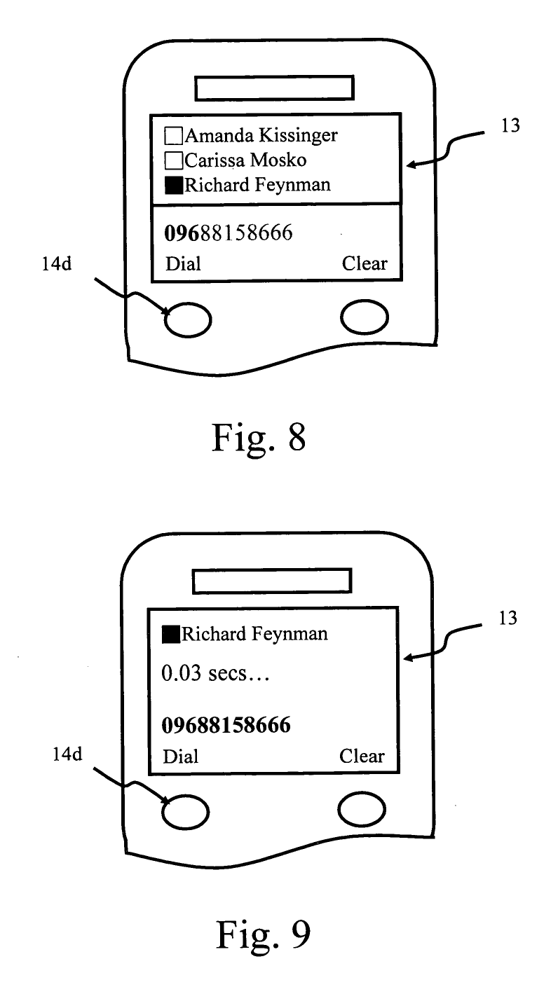

Please refer to FIG. 3 regarding the flow chart of the present invention. Please also refer to FIGS. 4˜9 in conjunction with FIG. 3 for understanding the subject matter of the present invention.

### Step 301:

Receiving input digits by a user:

For example, the user inputs “09”.

### Step 302:

Displaying the input digits:

Please refer to FIG. 4. “09” will be displayed on the screen 13.

### Step 303:

Comparing input digits with a phonebook 20:

Because the user inputs “09”, the processor 11 will execute software program 121 to compare “09” with built phone number 22˜24 of the phonebook 20.

### Step 304:

Finding any possible dialing target:

For example, dialing targets are Allen Wilson, Amanda Kissinger, Carissa Mosko, Chien-Ming Wang etc., because their first two digits of built phone number 22 are “09”.

### Step 305:

Displaying at least one of the possible dialing targets 30:

In FIG. 4, because of the size of the screen 13, the screen 13 displays three possible dialing targets 30, Allen Wilson, Amanda Kissinger, and Carissa Mosko.□ However, the user can use the input device 14 (e.g. up or down keys) to scroll the screen 13 so that the user can also see other possible dialing targets 30.

Please note that one of possible dialing targets is highlighted as a chosen target 40. In FIG. 4, Allen Wilson is the chosen target 40. Allen Wilson's phone number 09206544568 matches the input digit (e.g. “09”) defined as a target phone number 50 will also be displayed on the screen 13. Please also note that the input digit (e.g. “09”) is display clearer than the digits other than at least said one input digit (e.g. “206544568”).

Referring to FIG. 5, the user can use the input device 14 (e.g. up or down keys) to change the chosen target 40 from Allen Wilson to Amanda Kissinger. And therefore the target phone number 50 displayed on the screen 13 will be changed to Amanda Kissinger's built phone number, 09656548666.

Referring to FIG. 6 for another example, the user can use the input device 14 (e.g. up or down keys) to scroll the screen 13 to select new chosen target 40, Chien-Ming Wang. In the same way, Chien-Ming Wang's built phone number, 09886666777, becomes the target phone number 50.

### Step 306:

User input another input digit, or Dialing target phone number 50;

Supposed the user input another input digit, then go to step 301 again. For example, the user input another input digit “6”, so the accumulated input digits becomes “096” as shown on FIG. 7. With the same manner, Step 301˜Step 305 will go through again. Because input digits becomes “096”, the possible dialing targets 30 has changed to Amanda Kissinger, Carissa Mosko, and Richard Feynman because the first three digits of their built phone number match input digits “096”.

Assumed after digits “096” have been inputted, the user decide to make a call because the user's chosen target 40, “Richard Feynman”, is shown on the screen 13 at this moment. Then the user can press the dialing button 14d to call “Richard Feynman”, as shown on FIG. 9.

Please noted that once the user start to input the first digit, then Step 301 can begin. In fact, when the user input “0”, Step 301˜Step 305 is executed for the first time. When the user further input “9”, then the accumulated input digits “09” will go through Step 301˜Step 305 again. Therefore, the above description regarding Step 301 is the second time to be executed. However, the program can also be designed that Step 301 is activated only after two digits is inputted. For example, after digits “09” is inputted, Step 301˜Step 305 is executed for the first time.

Although the present invention has been explained in relation to its preferred embodiment, it is to be understood that many other possible modifications and variations can be made without departing from the spirit and scope of the invention as hereinafter claimed.

What is claimed is:

1. A method of dialing phone number prediction to facilitate a phone user to dial a phone number, comprising the steps of:
receiving at least one input digit;
displaying at least said one input digit;
comparing at least said one input digit with a phonebook, wherein the phonebook comprises a plurality of phone owners, and each phone owner has at least said one built phone number;
finding any possible dialing target from the phone owners, wherein at least said one built phone number of possible dialing target matches at least said one input digit; and
displaying at least one of the possible dialing targets.

2. The method of dialing phone number prediction as claimed in claim 1, at least one possible dialing target is highlighted defined as a chosen target which can be selected by the phone user.

3. The method of dialing phone number prediction as claimed in claim 2, wherein the built phone number of the chosen target which matches at least said one input digit defined as a target phone number will also be displayed.

4. The method of dialing phone number prediction as claimed in claim 3, wherein at least said one input digit of the target phone number is display clearer than the digits other than at least said one input digit.

5. The method of dialing phone number prediction as claimed in claim 2, wherein the phone has a dialing button, and the user can connect the chosen target by pressing the dialing button.

6. The method of dialing phone number prediction as claimed in claim 3, wherein the phone has a dialing button, and the user can connect the chosen target by pressing the dialing button without inputting the whole target phone number.

7. A telephone comprising a processor 11, a memory 12, and a screen 13, wherein the memory 12 comprises a phonebook and a computer program to be executed by the processor 11 to perform the steps of:
receiving at least one input digit;
displaying at least said one input digit;
comparing at least said one input digit with a phonebook, wherein the phonebook comprises a plurality of phone owners, and each phone owner has at least said one built phone number;
finding any possible dialing target from the phone owners, wherein at least said one built phone number of possible dialing target matches at least said one input digit; and
displaying at least one of the possible dialing targets.

8. The telephone as claimed in claim 7, at least one possible dialing target is highlighted defined as a chosen target which can be selected by the phone user.

9. The telephone as claimed in claim 8, wherein the built phone number of the chosen target which matches at least said one input digit defined as a target phone number will also be displayed.

10. The telephone as claimed in claim 9, wherein at least said one input digit of the target phone number is display clearer than the digits other than at least said one input digit.

11. The telephone as claimed in claim 8, wherein the phone has a dialing button, and the user can connect the chosen target by pressing the dialing button.

12. The telephone as claimed in claim 9, wherein the phone has a dialing button, and the user can connect the chosen target by pressing the dialing button without inputting the whole target phone number.
